(19) United States
(12) Patent Application Publication
(10) Pub. No.: US 2012/0240842 A1
(43) Pub. Date: Sep. 27, 2012

(54) CONSUMABLE PRODUCT USE TRACKING SYSTEM

(76) Inventors: Timothy Edwards, Del Mar, CA (US); Shaun Edwards, Del Mar, CA (US)

(21) Appl. No.: 13/170,299

(22) Filed: Jun. 28, 2011

Related U.S. Application Data
(63) Continuation-in-part of application No. 13/052,675, filed on Mar. 21, 2011.

(51) Int. Cl. G01D 13/22

(52) U.S. Cl. 116/327

(57) ABSTRACT

A consumable product use tracking system includes a consumable product handling apparatus having a first marker is moveable relative to a date indicia, wherein the first marker selectively identifies a distinct date from the date indicia, and a second marker is moveable relative to a time indicia, wherein the second marker identifies a distinct time from the time indicia. A marker positioning mechanism is associated with the first and second markers, the apparatus, or both, for securely holding the markers so as to identify the distinct date and time and prevent accidental or unintended movement of the markers to another date and time. The markers are selectively moved to identify the distinct date and time after each use or for a future use of the consumable product handling apparatus.

### FIELD OF THE INVENTION

The present invention generally relates to the tracking of consumable product use. More particularly, the present invention relates to a tracking system which helps one to remember the last time a consumable product—was used, such as, but not limited to, when an animal, plant or person was fed, given medication, changed, tested, or when a product was installed, replaced, cleaned, evaluated, changed. Alternatively, the present invention can be used to signify a future time when a consumable product is to be used. A consumable product can be anything ingested to oil filters to fertilizers.

### BACKGROUND OF THE INVENTION

People today lead busy lives. A typical person has to learn to multi-task throughout the day to make sure all the everyday chores are accomplished. Not only does one have to go to their daily job, but one might also have to get one's children ready for school, drop the children off at school, work a full day, pick up groceries on the way home, cook and serve dinner, do the laundry, clean the house, bathe the children and put them to sleep, pay the bills, read or watch the news, respond to emails, and then finally go to bed.

In all of this chaos it is hard to remember even simple tasks which you may have already done. There are many times when one has left the house and wondered whether the iron was turned off or whether they shut the garage door. An example of one simple task that is easily forgotten is whether the family pet was fed. One cannot simply ask the family pet whether they were fed today. Many pets will overeat if they have already been fed. Under-feeding or over-feeding a pet can lead to many problems, such as an inconsistent diet, under-nutrition, obesity, and also the stress and guilt of neglecting the proper care of one's pet.

Accordingly, there is a need for a simple and cost effective way to easily determine when the last time a consumable product was used, such as when the pet was fed. The present invention fulfills these needs and provides other related advantages.

### SUMMARY OF THE INVENTION

The consumable product use tracking system includes a consumable product handling apparatus. A date indicia is associated with the apparatus. A first marker is moveable relative to the date indicia, wherein the first marker selectively identifies a distinct date from the date indicia. A time indicia is associated with the apparatus. A second marker is moveable relative to the time indicia, wherein the second marker identifies a distinct time from the time indicia. A marker positioning mechanism is associated with the first and second markers, the apparatus, or both, for securely holding the markers so as to identify the distinct date and time and prevent accidental or unintended movement of the markers to another date and time. The markers are selectively moved to identify the distinct date and time after each use of the consumable product handling apparatus to remind a user of a last date and time the consumable product was used or given medication.

In other exemplary embodiments, the consumable product handling apparatus may comprise a food scoop, a food bowl or a food container for the transportation, selling, purchasing or feeding of food or medication for humans, animals or plants. The date and time indicia may be disposed along a length or about a circumference of the food handling apparatus. The markers are slidable relative to the date and time indicia, or alternatively, the markers are rotatable relative to the date and time indicia. The consumable product handling apparatus may comprise a food container and a removable lid. The date indicia or time indicia may be removably attached for accommodating different languages.

In another exemplary embodiment, a consumable product handling system may comprise a consumable product handling apparatus including a roller rotatable relative to the apparatus. Date or time indicia is associated with the roller. A roller positioning mechanism is associated with the roller, the apparatus, or both, for securely holding the roller so as to identify a distinct date or time from the date or time indicia and prevent accidental or unintended movement of the roller to another date or time. The roller may be selectively moved to identify the distinct date or time after a last time an animal was fed or given medication.

In other exemplary embodiments, the consumable product handling apparatus may comprise a food scoop, a food bowl or a food container for the transportation, selling, purchasing or feeding of food or medications as well as fertilizers, pool chemicals, sunscreens to name just a few. The consumable product handling apparatus may be used to identify the distinct date and time of a current feeding or medication application of the animal, human or plant. This may be accomplished by selectively moving the roller to identify the distinct date and time of the current feeding or medication application. Additionally, the consumable product handling apparatus may comprise a means for attachment to a food scoop, food bowl or food container. The means for attachment may comprise an adhesive, a magnet, a vacuum cup or even a hook and loop system.

In another exemplary embodiment, a consumable product use tracking system comprises a body and a battery associated with the body. An electronic processor is electrically connected to the battery, wherein the processor internally tracks the current date or time. A button is accessible by a user and in communication with the processor. An electronic readout is associated with the processor. When the button is pressed by the user it displays static electronic readout showing a distinct date and or time corresponding to a last time an animal, human or plant was fed or given medication. This and other embodiments could track more than one thing, for instance, the stand-alone embodiment could track fish feeding and fish tank filter change and could vacuum cup to the exterior of the fish tank.

In other exemplary embodiments, the body can be attached to a consumable product handling apparatus. The consumable product handling apparatus may comprise a food scoop, a food bowl or a food container for the transportation, selling, purchasing or feeding of animal, human or plant food or medications. The consumable product handling apparatus may be used to identify the static and distinct date and time of a current feeding or medication application of the animal as well as fertilizers, pool chemicals, sunscreens to name just a few. The body may comprise a means for attachment to a food scoop, food bowl, food container or even a watering can. The means for attachment may comprise an adhesive, a magnet, or a vacuum cup or hook and loop material. A timer and an alarm both may be associated with the processor, wherein the alarm sounds after a predetermined time has elapsed.

The exemplary embodiments presented herein relate to the tracking of a consumable product use. A consumable product can be a multitude of things including a medication, a food, a vitamin, a supplement or anything ingested into a human or an animal. A consumable product can also include products or actions that are done at specific intervals such as oil filter changes, eye contact case replacement, dental cleaning visits, use fertilizers, watering of a garden and the cleaning of a fish tank or a pet cage. The tracking may include the tracking of a previous use or the tracking of a future use. Anything that could require a tracking may be tracked by the exemplary embodiments of the present invention.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view of an exemplary food scoop embodying the present invention;

FIG. 2 is a side view of the embodiment of FIG. 1;

FIG. 3 is a top view of the embodiment of FIG. 1;

FIG. 4 is another top view of the embodiment of FIG. 1 showing the marker moved;

FIG. 5 is a perspective view of another exemplary food scoop embodying the present invention;

FIG. 6 is a partial top view of another exemplary food scoop embodying the present invention;

FIG. 7 is a partial top view of another exemplary food scoop embodying the present invention;

FIG. 8 is a perspective view of another exemplary food scoop embodying the present invention;

FIG. 9 is a perspective view of an exemplary food bowl embodying the present invention;

FIG. 10 is a perspective view of another exemplary food bowl embodying the present invention;

FIG. 11 is a perspective view of another exemplary food bowl embodying the present invention;

FIG. 12 is a perspective view of another exemplary food bowl embodying the present invention;

FIG. 13 is a perspective view of another exemplary food bowl embodying the present invention;

FIG. 14 is a perspective view of an exemplary food container embodying the present invention;

FIG. 15 is a perspective view of another exemplary food container embodying the present invention;

FIG. 16 is a perspective view of another exemplary food container embodying the present invention;

FIG. 17 is a perspective exploded view of another exemplary food container embodying the present invention;

FIG. 18 is a perspective view of the structure of FIG. 17 now assembled;

FIG. 19 is a perspective view of another exemplary food container embodying the present invention;

FIG. 20 is a view similar to FIG. 19 now with the scoop opened through a hand actuated lever;

FIG. 21 is a perspective view of the embodiment of FIG. 19 now showing the food container clipped to a bag;

FIG. 22 is a top view of another exemplary food scoop embodying the present invention;

FIG. 23 is a partial top view of another exemplary food scoop embodying the present invention;

FIG. 24 is a perspective view of another exemplary food container embodying the present invention;

FIG. 25 is a perspective view of another exemplary food scoop embodying the present invention;

FIG. 26 is a perspective view of another food container embodying the present invention;

FIG. 27 is a perspective view of another animal feeding reminder system embodying the present invention;

FIG. 28 is a rear perspective view of the structure of FIG. 27;

FIG. 29 is a perspective view of the structure of FIG. 27 now affixed to a bowl;

FIG. 30 is a perspective view of another exemplary embodiment of the present invention;

FIG. 31 is a perspective view of another exemplary embodiment of the present invention;

FIG. 32 is a perspective view of another exemplary embodiment of the present invention;

FIG. 33 is a perspective view of another exemplary embodiment of the present invention;

FIG. 34 is a perspective view of another exemplary embodiment of the present invention;

FIG. 35 is a top view of another exemplary embodiment of the present invention;

FIG. 36 is a perspective view of another exemplary embodiment of the present invention;

FIG. 37 is an exploded perspective view of another exemplary embodiment of the present invention;

FIG. 38 is a perspective view of the structure of FIG. 38 now assembled;

FIG. 39 is an exploded perspective view of another exemplary embodiment of the present invention;

FIG. 40 is a perspective view of the structure of FIG. 38 now assembled;

FIG. 41 is an exploded perspective view of another exemplary embodiment of the present invention;

FIG. 42 is a perspective view of the structure of FIG. 38 now assembled;

FIG. 43 is a perspective view of another exemplary embodiment of the present invention;

FIG. 44 is a perspective view of another exemplary embodiment of the present invention;

FIG. 45 is a perspective view of another variation similar to the structure of FIG. 44;

FIG. 46 is a perspective view of another exemplary embodiment of the present invention;

FIG. 47 is a perspective view of another exemplary embodiment of the present invention; and

FIG. 48 is a perspective view of another exemplary embodiment of the present invention.

### DETAILED DESCRIPTION OF THE PREFERRED EMBODIMENTS

As shown in the drawings for purposes of illustration, the present invention for a consumable product use tracking system is referred to generally by the reference number 10. The exemplary embodiments presented herein relate to the tracking of a consumable product use. A consumable product can be a multitude of things including a medication, a food, a vitamin, a supplement or anything ingested into a human or an animal. A consumable product can also include products or actions that are done at specific intervals such as oil filter changes, eye contact case replacement, dental cleaning visits, use of fertilizers, watering of a garden and the cleaning of a fish tank or a pet cage. The tracking may include the tracking of a previous use or the tracking of a future use. Anything that could require a tracking may be tracked by the exemplary embodiments of the present invention.

The consumable product use tracking system 10 of the present invention includes a food handling apparatus 12. The food handing apparatus 12 can comprise a food scoop 14, a food bowl 16, or a food container 18 for the transportation, selling, or purchasing of ingestible food products. It is to be understood by those skilled in the art that the food handling apparatus 12 can further handle consumable products including medications. Alternatively, the food handling apparatus 12 can handle a combination mixture of food and medication.

A date or time indicia 20 is associated with the food handling apparatus 12. The date or time indicia 20 can comprise a multitude of information. For instance, the information can be days of the week, days of the month, or months of the year. The date and time indicia can include specific times of the day or simply an a.m. or p.m. moniker. The intervals of time displayed depend on the specific pet or animal the food apparatus is associated with. For instance, dogs may be fed twice a day and therefore have two indicia per each day of the week. Alternatively, a lizard may be fed only once a week and accordingly its indicia includes the 52 weeks in the year. As can be seen by one skilled in the art, a multitude of actual dates and times can be utilized and this specification is not intended to limit it to the precise form described herein.

A marker 22 is associated with the food handling apparatus 12 and moveable relative to the indicia 20. The marker 22 selectively identifies a distinct date or time 24 from the date or time indicia. In some embodiments the marker 22 moves relative to the food handing apparatus 12. In other embodiments the marker 22 remains stationary while the date or time indicia move relative to the marker 22 and food handling apparatus 12.

A marker positioning mechanism 26 is associated with the marker 22, the apparatus 12, or both. The marker positioning mechanism 26 securely holds the marker 22 so as to identify the distinct date or time 24 and prevent accidental or unintended movement of the marker 22 to another date or time. Therefore, the marker 22 can be selectively moved to identify the distinct date or time 24 after each use of the food handling apparatus 12 to remind a user of a last time an animal was fed.

The marker positioning mechanism 26 can be a multitude of designs. A frictional bias or frictional snap point may be designed into the various structures of the apparatus 12, the marker 22, or other various portions such that the marker 22 is frictionally held in place relative to the date or time indicia 20. The frictional bias is low enough that a user can manually move the marker 22 to indicate a new date or time, yet the marker 22 will remain sufficiently in place such that it doesn't easily get accidentally moved. The frictional bias can be accomplished with springs, connectors, snap fits, interference fits, magnets, puncture holes, or any other suitable method known today. As can be seen by one skilled in the art, there are a multitude of possible designs and this specification is not intended to limit it to the precise forms described herein.

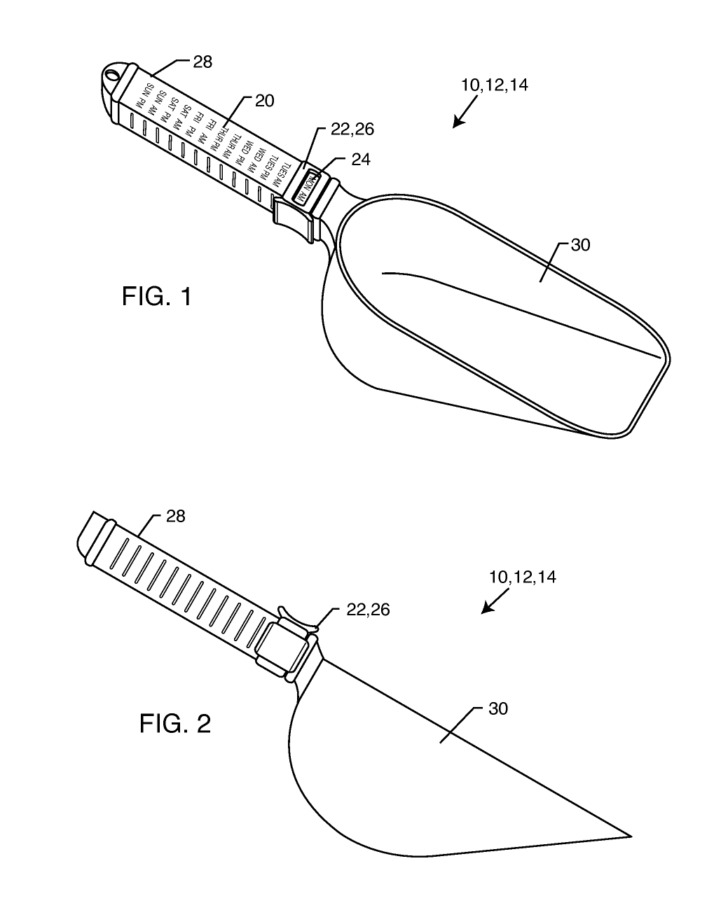

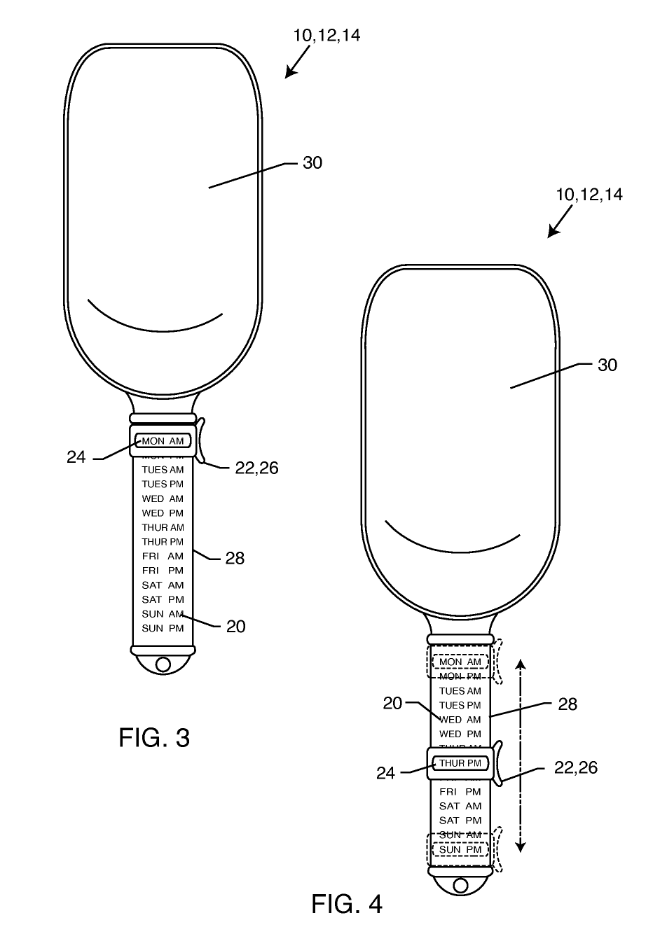

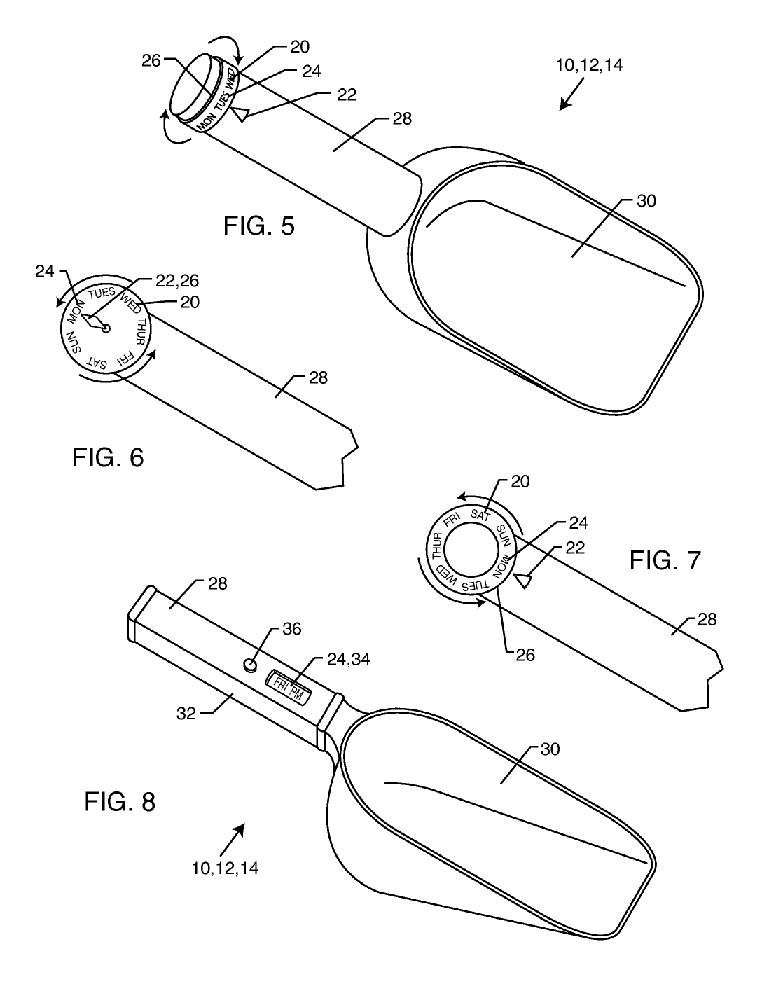

FIGS. 1-4 are views of an exemplary food scoop 12 embodying the present invention. The food scoop 12 can comprise a handle 28 attached to a scoop 30. The date or time indicia 20 can be disposed along a length or about a circumference of the food handling apparatus 12, or in this case the handle 28. The marker 22 can be slidable or movable relative to the date or time indicia 20. Alternatively, the marker 22 can be rotatable relative to the date or time indicia 20 as shown in FIGS. 5-7. FIG. 5 shows the marker 22 rotating around the circumference of the handle 28. FIG. 6 shows the date and time indicia 20 circularly disposed at the end of the handle 28 where now the marker 22 rotates like a clock. FIG. 7 shows the marker 22 formed as an integral part of the handle 28 where now the date and time indicia 20 rotate about the end of the handle 28.

In yet another exemplary embodiment as shown in FIG. 8, the food handling apparatus 12 can include an electronic processor 32 and an electronic readout 34 for displaying the distinct date or time 24. This embodiment uses an internal battery, whether rechargeable or replaceable. A button 36, or a plurality of buttons 36, can be used to control the electronic readout 34 such that it correctly displays the distinct date or time 24.

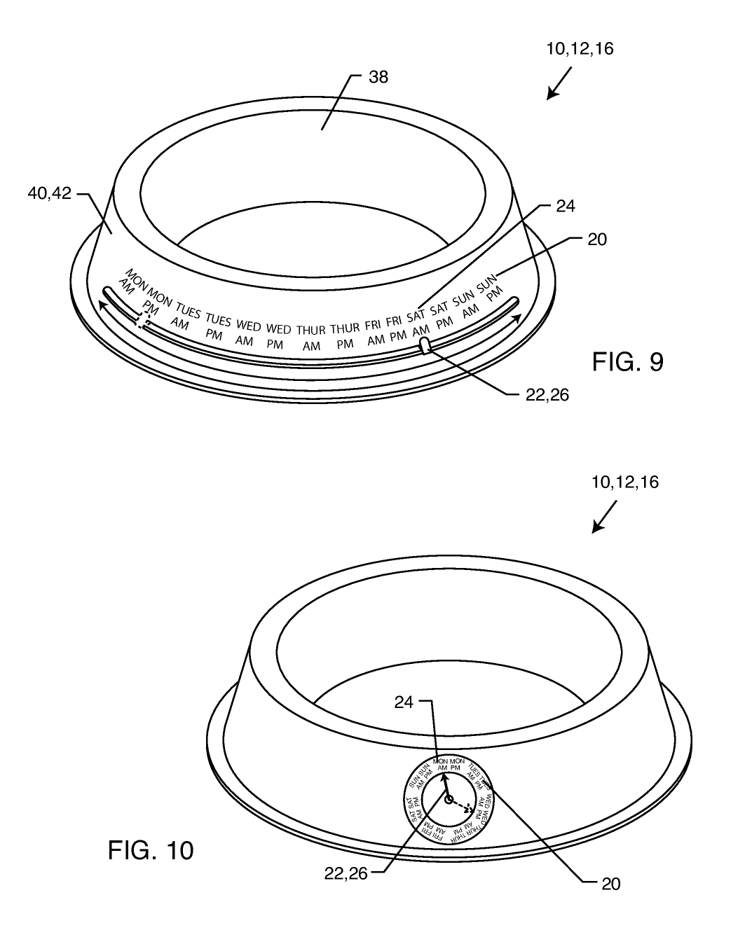

FIGS. 9-13 are various embodiments of an exemplary food bowl 16. FIG. 9 is a perspective view of an exemplary food bowl 14 where the food bowl 14 comprises a bowl portion 38 and a base portion 40. The base 40 has the date or time indicia 20 disposed along its outside circumferential surface 42. The marker 22 and marker positioning mechanism 26 are slidable relative to the base 40. The marker 22 can be moved to identify the distinct date or time 24.

FIG. 10 is a perspective view of another exemplary food bowl 14 where the date or time indicia 20 are disposed in a circular fashion similar to a clock. The marker 22 then is rotatable like the hand of a clock such that it then can identify the distinct date or time 24.

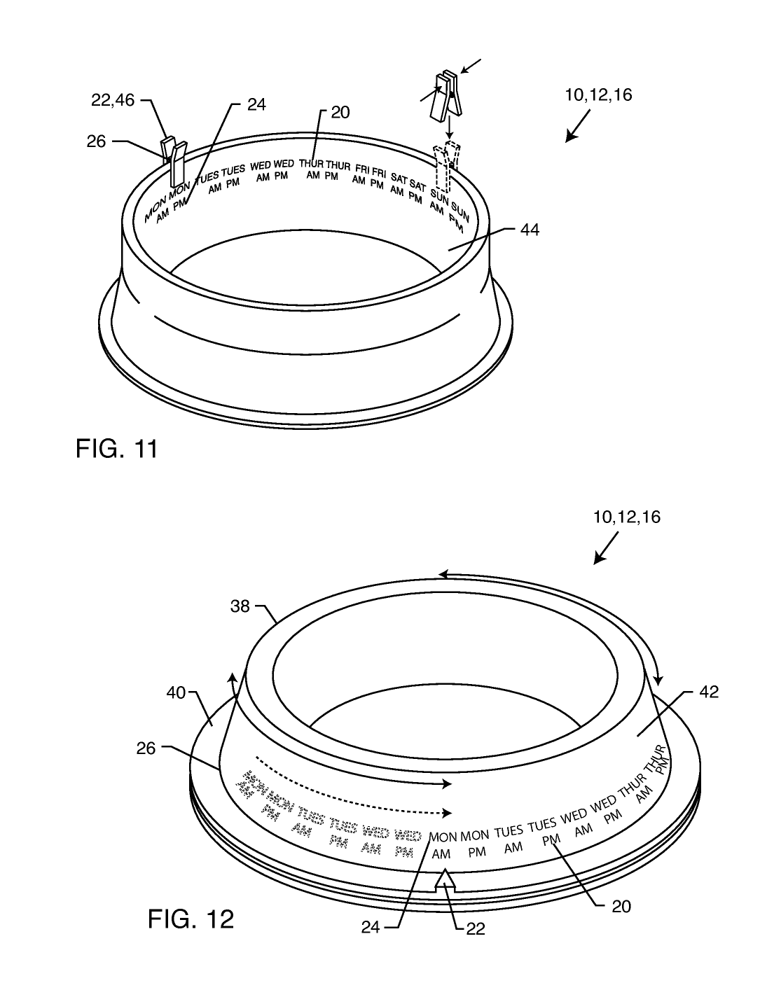

FIG. 11 is a perspective view of another exemplary food bowl 14 where the date or time indicia 20 is disposed on an inside circumferential surface 44 of the bowl 16. A removable and positionable marker 22 / clip 46 then can identify the distinct date or time 24.

FIG. 12 is a perspective view of another exemplary food bowl 14 where the bowl portion 38 rotates relative to the base portion 40. The marker 22 is formed as part of the base 40. The date or time indicia 20 is disposed on the outside circumferential surface 42 of the bowl 38.

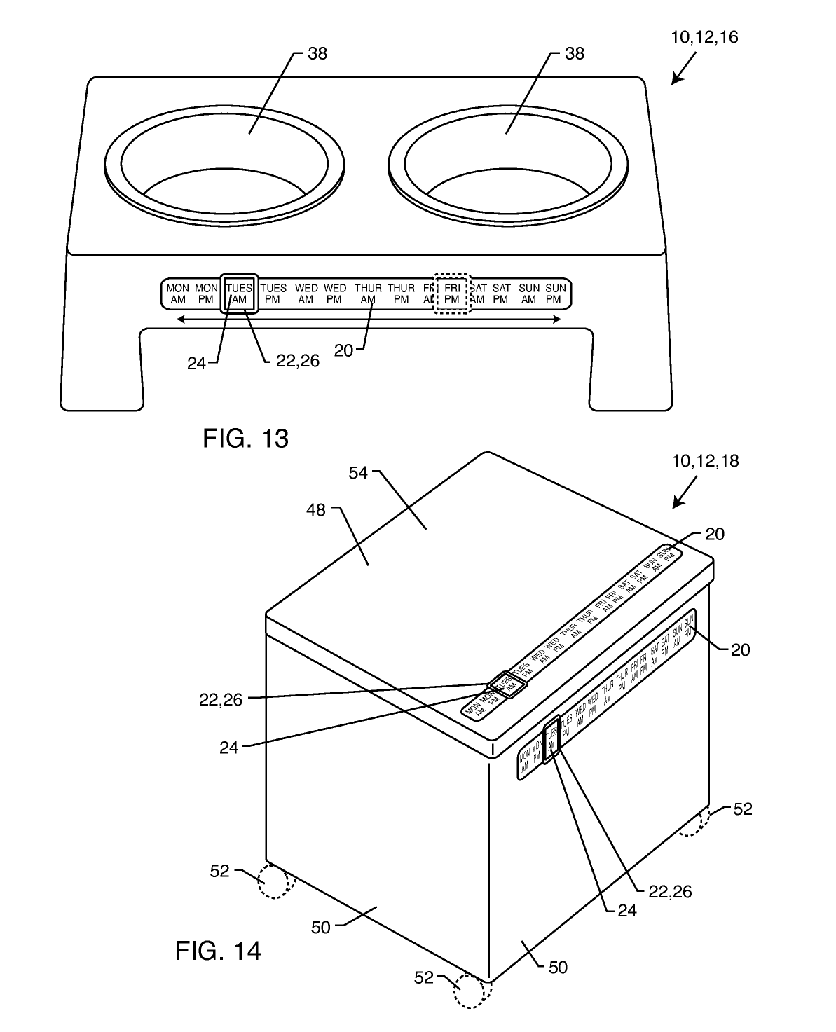

FIG. 13 is a perspective view of another exemplary food bowl 14 where now there are two bowls 38. The marker 22 is slidable along a base portion 40 and identifies a distinct date or time 24 from the date or time indicia 20.

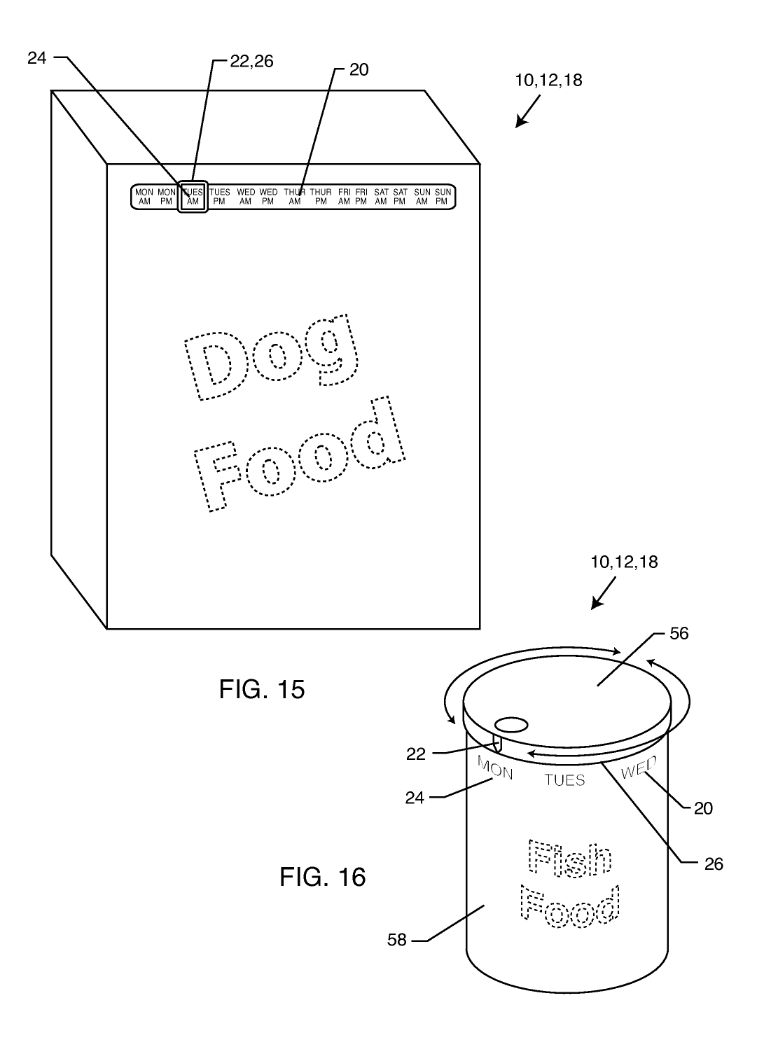

FIGS. 14-16 are exemplary embodiment of food containers 18. FIG. 14 is a perspective view of an exemplary food container 18 where the marker 22 can be slidable along a top surface 48 or a side surface 50. The food container 18 can be shaped in a multitude of sizes and shapes and include wheels 52 at the bottom for ease of moving. In this embodiment the food container 18 includes a lid 54 that is pivotable such that access is allowed to the inside. FIG. 15 is a perspective view of another exemplary food container 18 embodying the present invention.

FIG. 16 is a perspective view of another exemplary food container 18, where the food container 18 can comprise a first portion 56 rotatable relative to a second portion 58. One of the portions (56 or 58) can include the date or time indicia 20 and the other portion (56 or 58) can include the marker 22. Accordingly, the marker 22 identifies the distinct date or time 24 from the date or time indicia 20.

As can be seen, the consumable product use tracking system 10 includes the step of utilizing the food handling apparatus 12 to identify the distinct date or time 24 of a current feeding of the animal. Accordingly, this includes the step of selectively moving the marker 22 to identify the distinct date or time 24 of the current feeding. Remembering the last time the animal was fed can be ascertained simply by reading the marker 22 and the correspondingly marked distinct time or date 24.

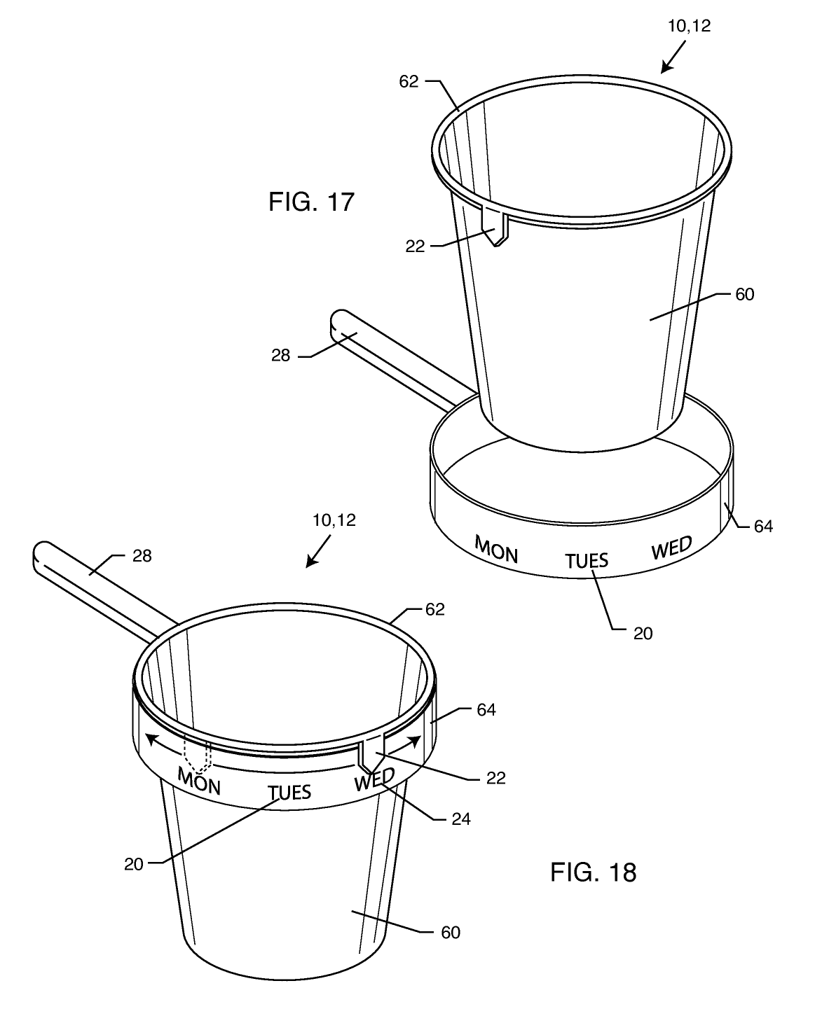

FIG. 17 is a perspective exploded view of another exemplary food handling apparatus 12 embodying the present invention now in the form of a bucket 60. FIG. 18 is a perspective view of the structure of FIG. 17 where the handle 28 is now assembled and fits underneath the rim 62 of the bucket 60. The marker 22 is formed as part of the rim 62 of the bucket 60. The handle 28 is rotatable relative to the bucket 60 and marker 22. The handle 28 is connected to a ring portion 64 which captures the rim 62 of the bucket 60. The ring 64 includes the date or time indicia 20 to which the marker 22 can identify a distinct date or time 24. It is understood that a frictional fit exists between the bucket 60 and the ring 64 such that the ring 64 remains in place once it is positioned. As can be understood by one skilled the art, the bucket 60 could include the date or time indicia 20 and the ring portion 64 of the handle 28 include the marker 22.

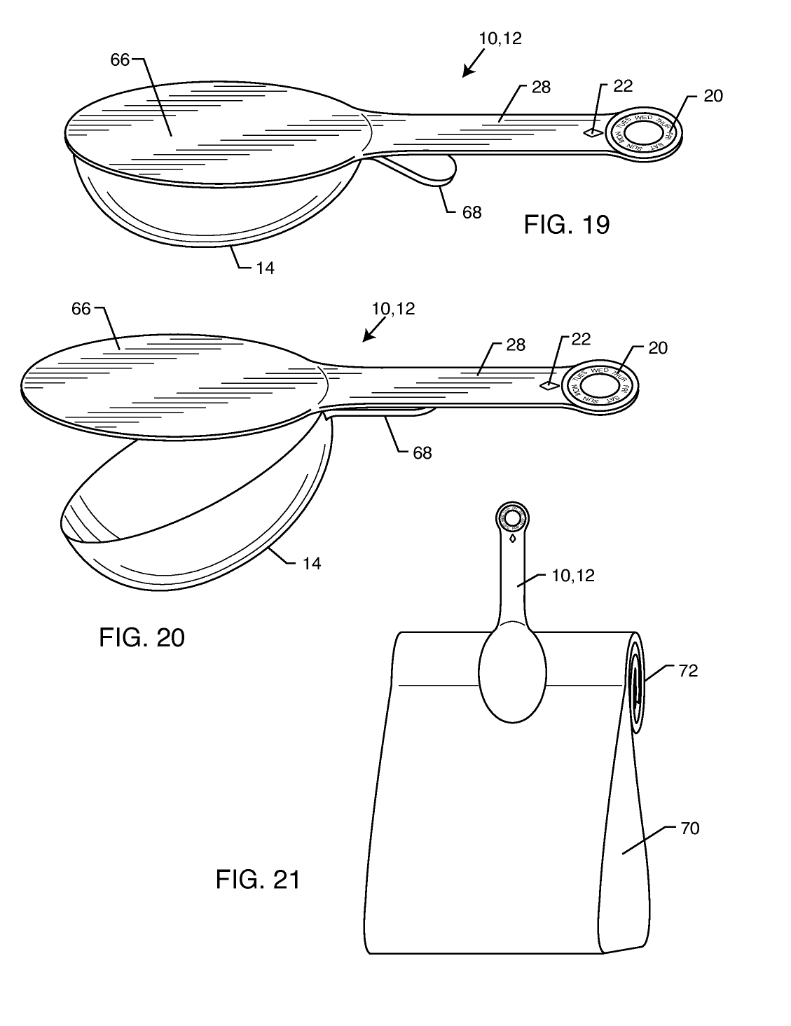

FIG. 19 is a perspective view of another exemplary food handling apparatus 12. In this embodiment the food scoop 14 is pivotably attached to the handle 28. The handle 28 extends over and about the food scoop 14 such that it forms a cover 66. The cover 66 acts as a lid to hold the contents of the food scoop 14 within in a closed position. The food scoop 14 can be biased through a spring or other means known in the art to bias it in the closed position such that it closes and seals with the cover 66. FIG. 19 shows the food scoop 14 and the cover 66 in the closed position.

A lever 68 is formed as part of the food scoop 14. The lever 68 can be actuated by the user when the handle 28 is grasped overcoming the internal bias. The lever 68 is accessible to the user's fingers and can be squeezed. When the lever 68 is squeezed, it opens the food scoop 14 relative to the cover 66. FIG. 20 is a view similar to FIG. 19 now with the food scoop 14 opened through the hand actuated lever 68.

This embodiment not only keeps the contents of the food scoop 14 secure, it can be used to hold a bag 70 closed. FIG. 21 is a perspective view of the embodiment of FIG. 19 now showing the food handling apparatus 12 clipped to the bag 70. Many types of animal feed or medication are purchased within a bag-like container. The bag 70 is generally opened at the top and can then be rolled up for closure creating a rolled up portion 72. However, most rolled up bags tend to unravel and open unless they are securely held closed. Typically either tape or a removable clip is used to hold the bag 70 shut. The food handling apparatus 12 can now be used to hold the bag 70 securely closed. The lever 68 can be actuated by the user opening the food scoop 14 relative to the cover 66. Then this opening can be inserted over top of the rolled up portion 72. When the lever 68 is released, the bias of the spring or other mechanical means keeps the rolled up portion 72 securely closed. It is to be understood by those skilled in the art that the embodiments shown in FIGS. 19-21 can be used with any of the marker positioning mechanisms 26 shown and described throughout this specification, and is to not be limited to the precise form shown herein.

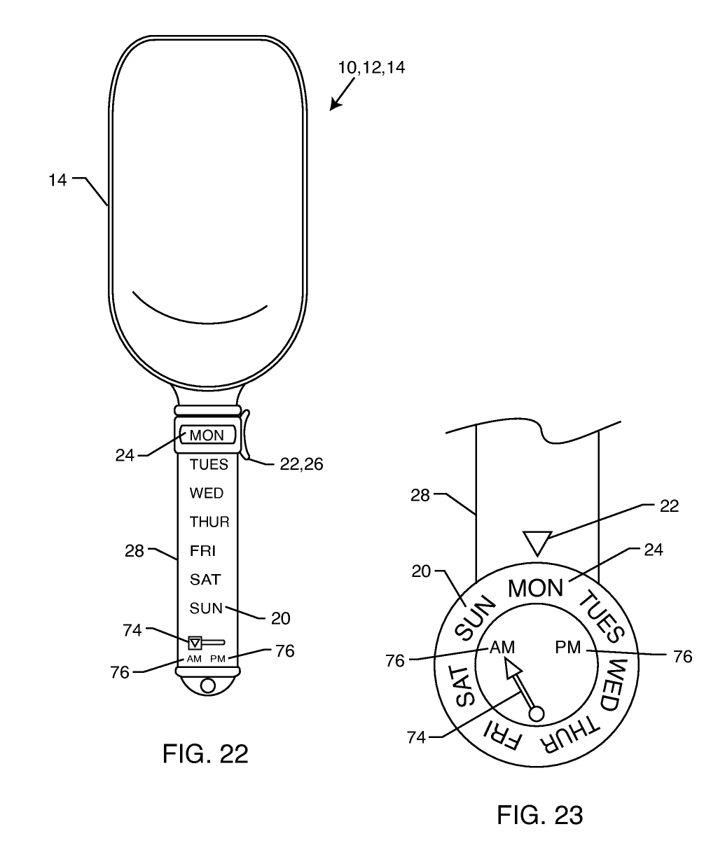

FIG. 22 is a top view of another exemplary food scoop 14. In this embodiment the days of the week can be separately identified apart from whether it is am or pm. A distinct day of the week 24 can be indicated from the days of the week indicia 20 through the use of a marker 26 and marker positioning mechanism 26. However, now an am/pm indicator 74 can be selectively moved to further indicate whether the last feeding of food or medication was done in the am or pm time periods as seen with the am/pm indicia 76.

FIG. 23 is a partial top view of another exemplary handle 28 embodying a separately identifiable am or pm. This embodiment is similar to FIG. 7, but now the am/pm indicator 74 can be pivoted to identify whether the last feeding of food or medication was during the am or pm by indicating the appropriate am/pm indicia 76. Similar to FIG. 7, the days of the week indicia 20 can be rotated such that the marker 22 identifies a distinct day of the week 24.

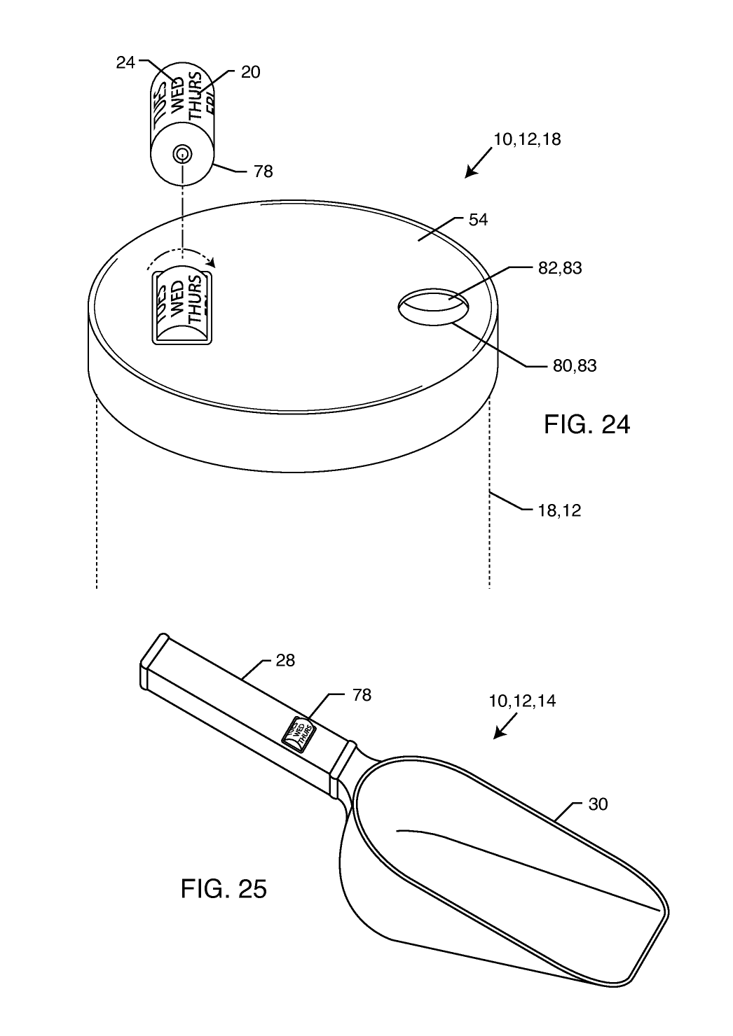

FIG. 24 is a perspective view of another exemplary food container 18 now with a roller indicator 78 formed as part of the lid 54. The roller indicator 78 includes the date or time indicia 20 on its outside surface. The roller indicator 78 is rotatably attached to the lid 54 such that it can be selectively positioned indicating a distinct date or time 24 of the last feeding of food or medication. The roller indicator 78 has a frictional bias such that it holds its position once it has been rotated to the desired position. The lid 54 includes a hole 80. The lid 54 is rotated such that the lid hole 80 matches and aligns with a container hole 82 in the food container 18 thereby forming a dispensing aperture 83. Food or medication can now fall out through the dispensing aperture 83. The lid 54 is then closed by rotating it such that the lid hole 80 does not coincide with the container hole 82 in the food container 18.

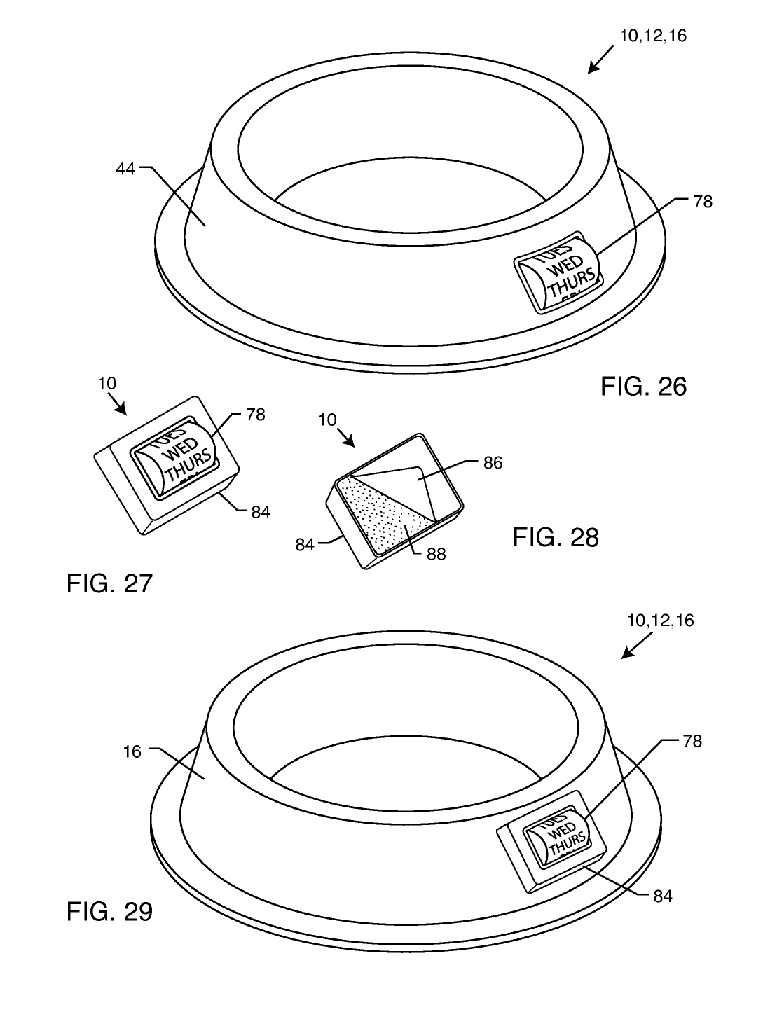

FIG. 25 is a perspective view of another exemplary food scoop 14 embodying the roller indicator 78 on FIG. 24. The roller indicator 78 is rotatably attached to the handle 28. FIG. 26 is a perspective view of another food bowl 16 embodying the roller indicator 78. The roller indicator 78 is rotatably attached to the outside circumferential surface 44.

FIG. 27 is a perspective view of another consumable product use tracking system 10 embodying the roller indicator 78. FIG. 28 is a rear perspective view of the structure of FIG. 27. The roller indicator 78 is rotatable relative to an attachable body 84. The body 84 can be attached to a variety of structures including food scoops, food bags, food containers, food bowls, medicine containers, or other nearby structures such as a refrigerator or cabinet. FIG. 29 is a perspective view of the attachable body 84 being adhered to a food bowl 16. The body 84 can be attached through a multitude of methods, including using an adhesive as shown in FIG. 28. A temporary backing 86 is removed exposing the adhesive 88 which is attached to the back of the body 84. Alternatively, a magnet may be used to affix the body 84 to a refrigerator or other metallic surface. Alternatively, the body 84 may be affixed through the use of a suction cup on a smooth surface or even a hook and loop material with adhesive backing. Creating an affixable roller indicator 78 allows the consumable product use tracking system 10 to be positioned by the user on a multitude of objects that are already in use and removes the need for purchasing a new food handling apparatus 12. As can be seen by one skilled in the art there a multitude of methods to attach the body 84 and this disclosure is not limited to the precise forms described herein.

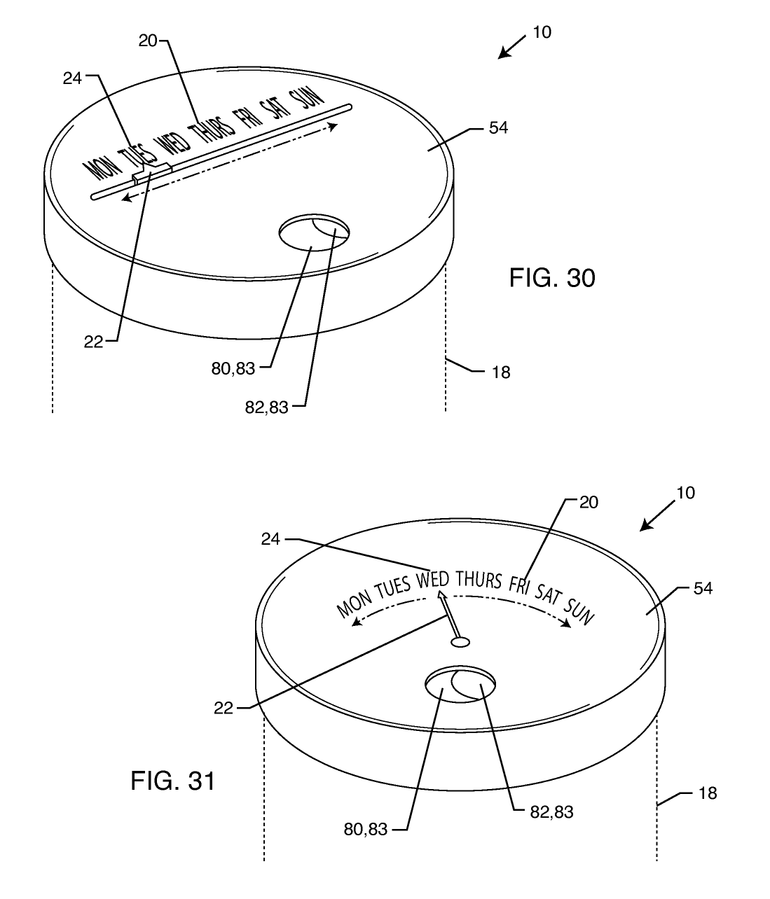

FIG. 30 is a perspective view of another exemplary embodiment of a lid 54 for a container 18 which could contain a consumable product such as either food, medicine, or a combination thereof. The lid 54 can either be purchased with the container 18 or be used on a standard size container 18. The lid 54 has a slidable marker 22 which indicates a distinct date or time 24 from the date or time indicia 20. The marker 22 has just enough internal friction to keep it in place once it is positioned. Similar to FIG. 24, this embodiment has a lid hole 80 which can be aligned with a container hole 82 forming a dispensing aperture 83.

FIG. 31 is a perspective view of another exemplary embodiment of a lid 54 for a container 18. This embodiment is similar to the structure of FIG. 30 now with a pivotable marker 22. The pivotable marker 22 has just enough internal friction to keep it in place once it is positioned. Similar to FIGS. 24 and 30, this embodiment also has a lid hole 80 which can be aligned with a container hole 82 forming a dispensing aperture 83.

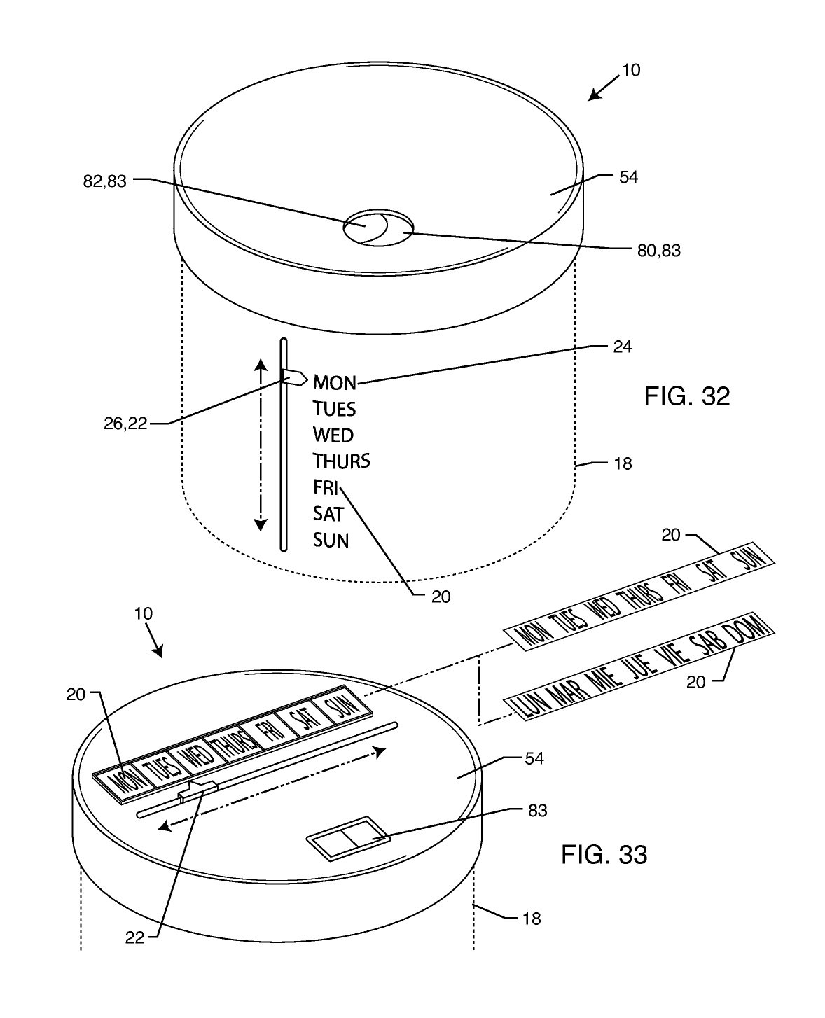

FIG. 32 is a perspective view of another exemplary embodiment of a consumable product use tracking system 10 now with the marker positioning mechanism 26 attached to the outside of the container 18. A marker 22 slides up and down the height of the container 18 indicating a distinct date or time 24 from the date or time indicia 20. The marker 22 has just enough internal friction to keep it in place once it is positioned. A lid 54 can be used to dispense food or medicine through the dispensing aperture 80.

FIG. 33 is a perspective view of another exemplary embodiment of a lid 54 for a container 18. In this embodiment the date or time indicia 20 is adhered to the lid 54. This allows various languages to be used for the date or time indicia 20. As an example in FIG. 33, English and Spanish date or time indicia 20 is shown. The user would choose the appropriate language, and then affix is to the top of the lid 54. The marker 22 can then be used to indicate a distinct date or time 24 from the date or time indicia 20. As in other exemplary embodiments, the marker 22 would have just enough internal friction to keep it in place once it is positioned. As shown in this embodiment, the dispensing aperture 83 comprises a door or slide which can be opened such that food or medicine can be dispensed.

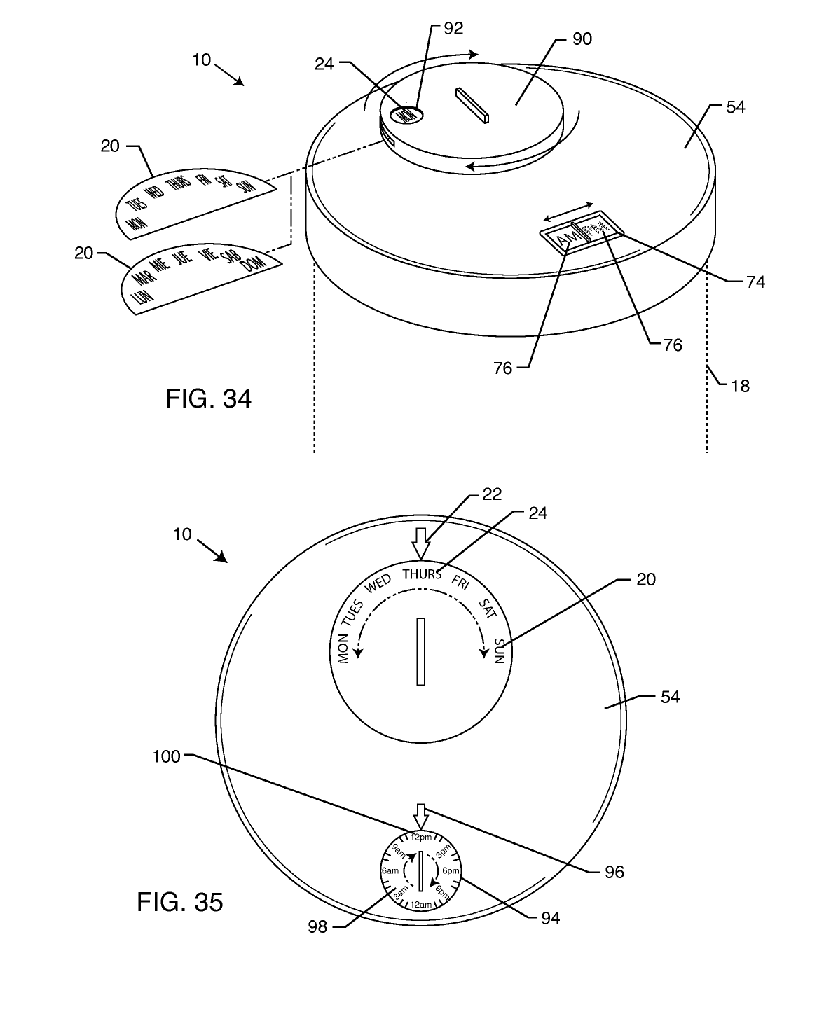

FIG. 34 is a perspective view of yet another exemplary embodiment of a lid 54 for a container 18. A rotatable dial 90 includes a hole 92, where the dial 90 is placed over top of the date or time indicia 20. A distinct date or time 24 can then be viewed through the hole 92. The dial 90 has just enough internal friction to keep it in place once it has been positioned. Furthermore, the lid 54 includes an am/pm indicator 74. A slidable door blocks either the am or pm indicia 76 from being viewed.

FIG. 35 is a top view of yet another exemplary embodiment of a lid 54 for a container 18. The date indicia 20 is rotatable relative to the lid 54. A marker 22 identifies a distinct date 24 from the date indicia 20. The lid 54 further includes a rotatable time dial 94. The marker 96 identifies a distinct time 100 from the time indicia 98.

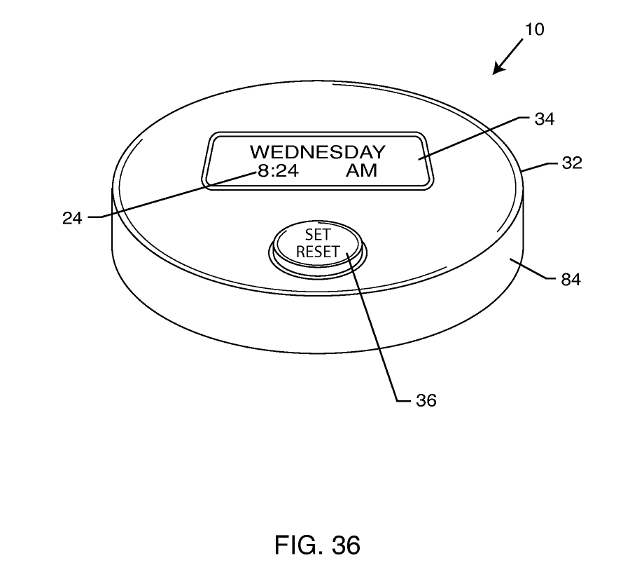

FIG. 36 is a perspective view of an exemplary consumable product use tracking system 10 including an attachable body 84 similar to FIGS. 27-28. The body 84 can be attached with an adhesive, magnet, or suction cup or even hook and loop material with adhesive backing as earlier described and detailed. An electronic processor 32 keeps track of the current date and time internally and can then display the exact date and time when the button 36 was pressed on an electronic readout 34 when the button 36 is pressed. The tracking system 10 acts as a time stamp such that a user can see the last time an animal, human or plant was given food, medicine, or fertilizer. All that is required is for the user to press the button 36 such that it displays a distinct time or date 24 as a time stamp. When the user then later reviews the electronic display, it will indicate the last time an animal, human or plant was given food or medicine. Because of this embodiment's ability to track day, date, and time it can be used in tracking the use of any type of consumable product but its cost may make it impractical for some uses. This electronic version also has the ability to track the use of more than one product just by adding a second level of programming and perhaps a second button to move the display window from one tracked product to another.

In another exemplary embodiment similar to FIG. 36, the tracking system 10 can include a stop watch / timer functionality such that when the button 36 is pressed, it will run a countdown from a preselected time to zero. For instance, the preselected time can be 12 hours or 24 hours. Once zero is reached, an alarm may sound or the electronic readout 34 will display that a feeding is required. When the button 36 is pressed again, it will reset the timer and a new countdown begins.

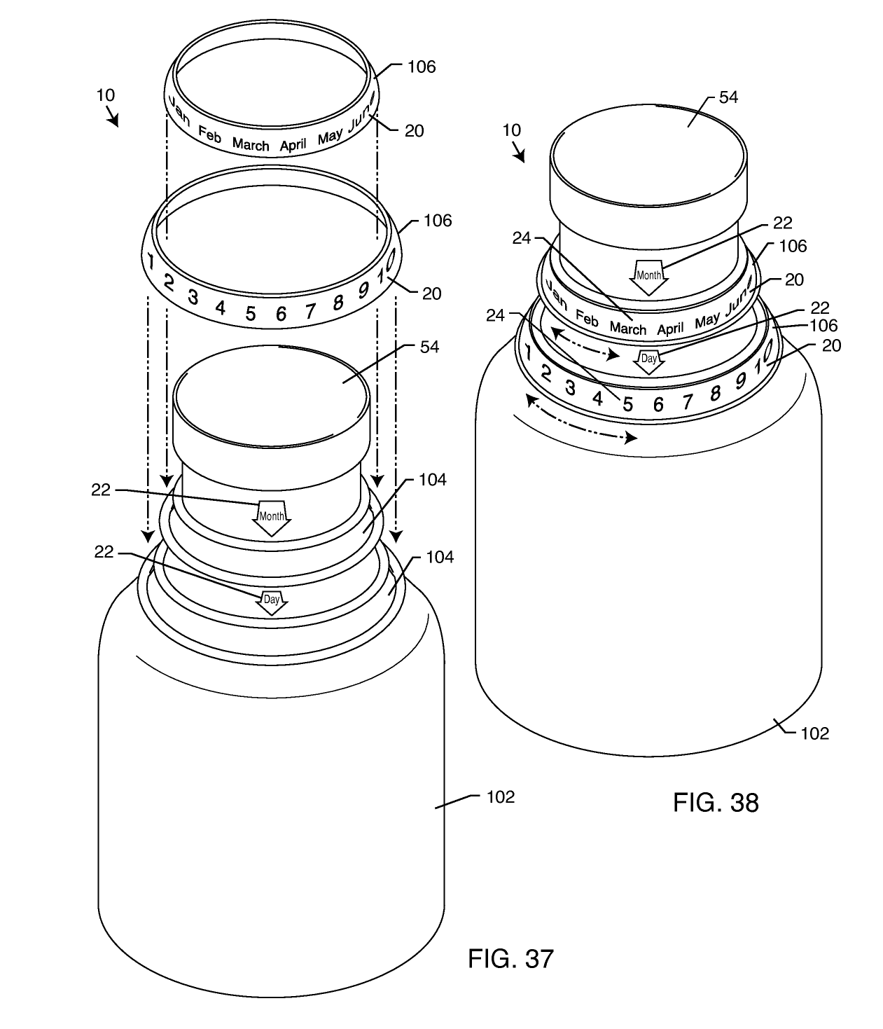

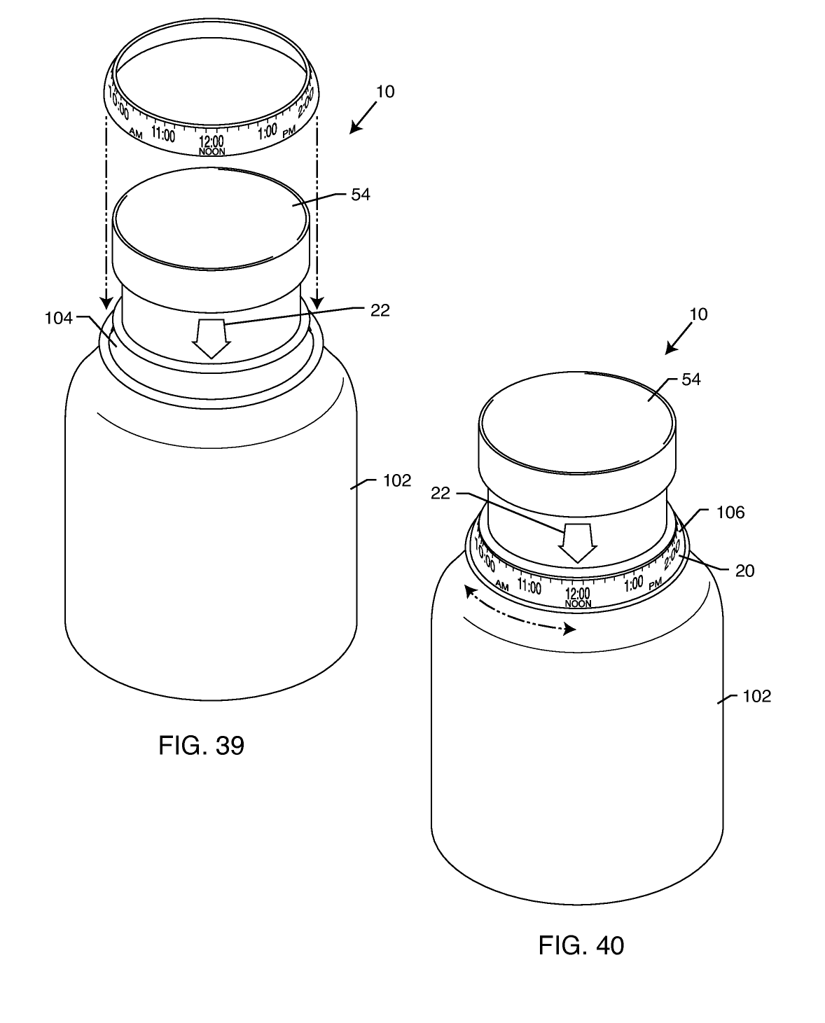

FIG. 37 is an exploded view of another exemplary consumable use product tracking system 10. FIG. 38 is an assembled view of the structure of FIG. 37. The bottle 102 has a removable lid 54. Along the neck of the bottle 102 are circumferential grooves 104. The grooves 104 receive rings 106. The rings 106 include date or time indicia 20. A marker 22 is displayed or formed on the neck of the bottle 102 pointing to a distinct date or time 24. The rings 106 are rotatable around the neck of the bottle 102. The rings 106 are either held in place relative to the bottle 102 either through a friction or a snap fit. The bottle 102 can now be used to dispense a variety of consumable products and each time the rings 106 can be moved to indicate either a future use or a previous use. FIGS. 39 and 40 are another variation similar to the bottle 102 of FIGS. 37 and 38, now with only one ring 106. As can be seen by one skilled in the art, a variety of different groove 104 and ring 106 combinations are possible, as this disclosure is not limited to just the ones shown and depicted herein.

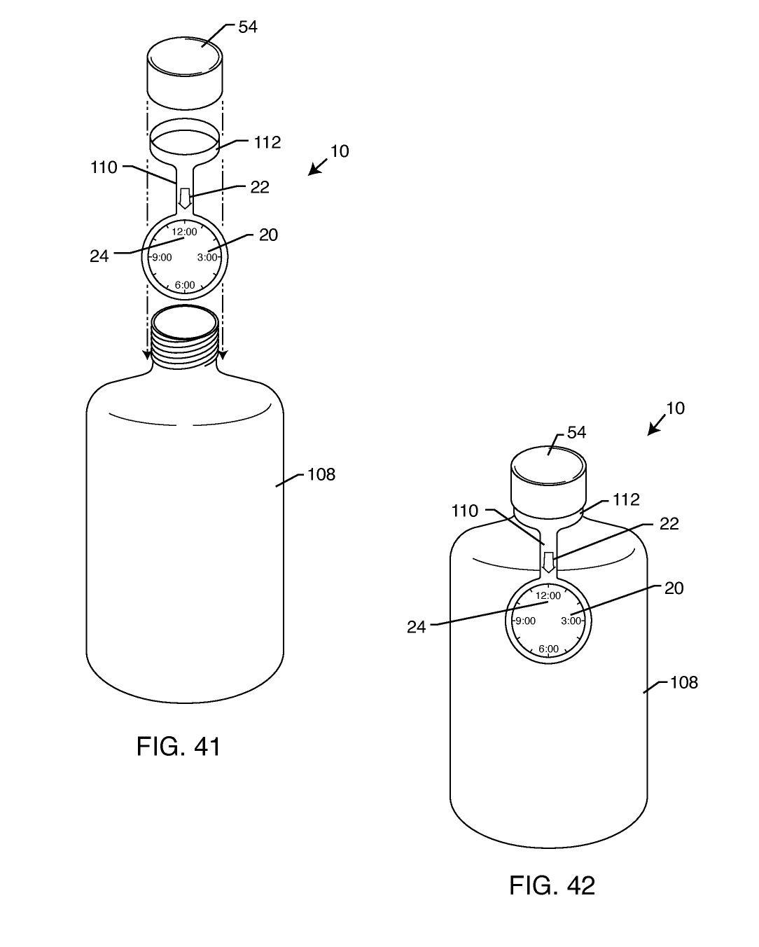

FIG. 41 is a perspective view of another exemplary consumable use product tracking system 10. FIG. 42 is an assembled view of the structure of FIG. 42. A standard bottle 108 is depicted with a lid 54. The bottle 108 is a typical size and shape of bottles commonly found and purchased in stores. A device 110 is shaped and sized to fit over the neck of the bottle 108. The device 110 includes a collar 112 which can be slipped over and around the neck of the bottle 108. A wheel 114 is rotatably attached relative to the collar 112 and device 110. The wheel 114 includes the date or time indicia 20. The device 110 includes the marker 22. The wheel 114 can be rotated and secured in position to then indicate a distinct date or time 24 by the marker 22.

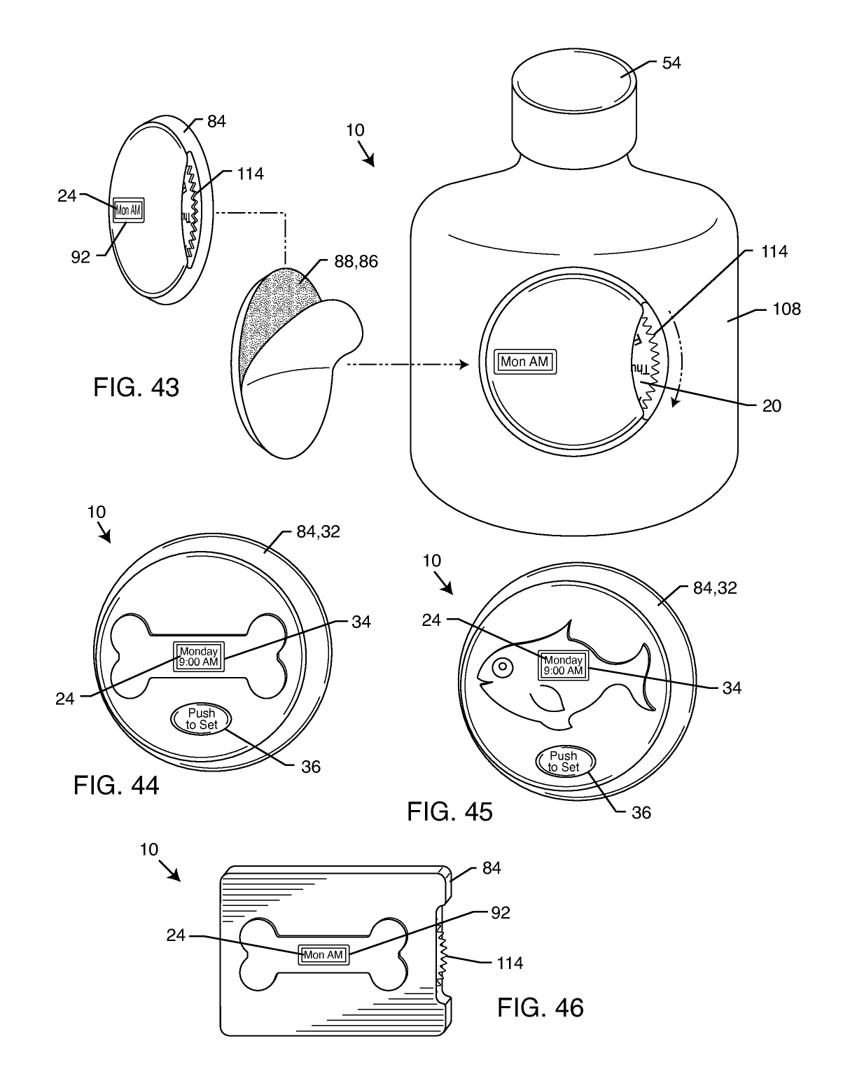

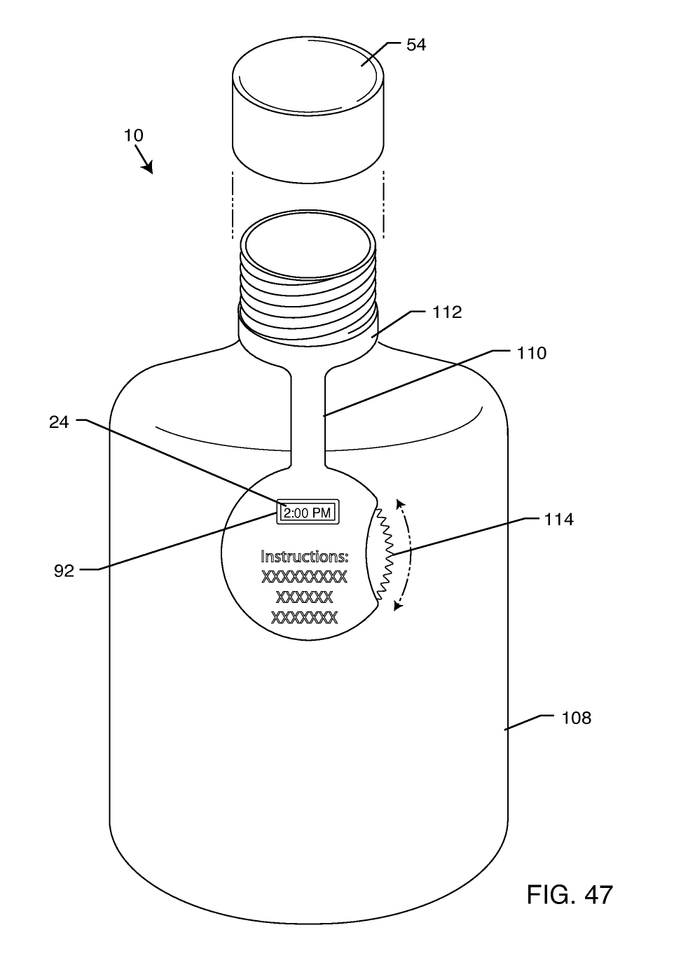

FIGS. 43 and 46 are perspective views of another exemplary consumable product use tracking system 10. Here, an attachable body 84 can have an adhesive 88 along the backing 86 of the body. The attachable body 84 can then be adhered to a bottle 108. A wheel 114 is manually rotatable by the user. The wheel 114 includes the date or time indicia 20. A distinct date or time 24 is shown through a hole or aperture 92.

FIGS. 44 and 45 are perspective views of another exemplary consumable product use tracking system 10 similar to FIGS. 43 and 46. Now, the wheel 114 has been replaced with an electronic processor 32 and an electronic readout 34. A button 36 is used to advance or change the electronic readout. As can be seen here, a fish and dog bone design can be integrated into the system 10 to signify the particular use of the device.

FIG. 47 is a perspective view of another exemplary consumable product use tracking system 10. Here, the device 110 with a collar 112 now has a wheel 114 where the distinct date or time 24 is shown through the hole or aperture 92. The device 110 can also include an adhesive 88 to help adhere it to the bottle 108.

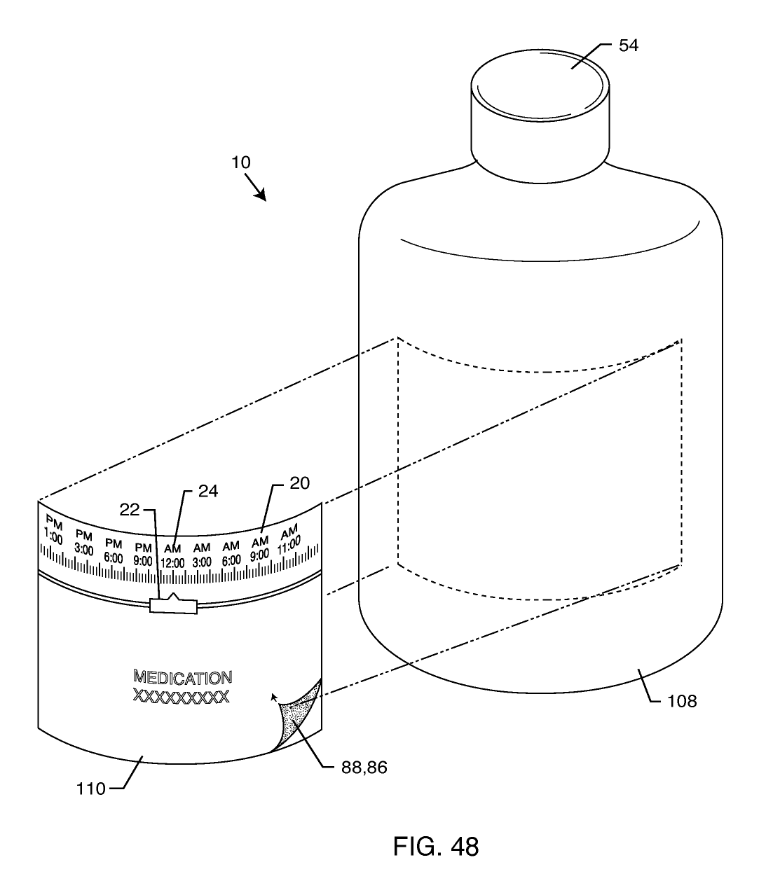

FIG. 48 is yet another perspective view of an exemplary consumable product use tracking system 10. Here, the device 110 is a flexible substrate that can conform to the various surfaces it is attached to. An adhesive 88 is placed along the backing 86 such that the device 110 can adhere to a bottle 108. The device 110 includes date or time indicia 20. A marker 22 is slidable along the device 110 and can then indicate a distinct date or time 24 from the date or time indicia 20. The marker 22 is slidable by the user but can also retain its position once moved into place.

Although several embodiments have been described in detail for purposes of illustration, various modifications may be made to each without departing from the scope and spirit of the invention. Accordingly, the invention is not to be limited, except as by the appended claims.

What is claimed is:

1. A consumable product use tracking system, comprising:
a consumable product handling apparatus;
date indicia associated with the apparatus;
a first marker moveable relative to the date indicia, wherein the first marker selectively identifies a distinct date from the date indicia;
time indicia associated with the apparatus;
a second marker moveable relative to the time indicia, wherein the second marker identifies a distinct time from the time indicia; and
a marker positioning mechanism associated with first and second markers, the apparatus, or both, for securely holding the markers so as to identify the distinct date and time and prevent accidental or unintended movement of the markers to another date and time;
wherein the markers are selectively moved to identify the distinct date and time after each use of the consumable product handling apparatus to remind a user of a last day, date and/or time the consumable product was used.

2. The system of claim 1, wherein the consumable product handling apparatus comprises a scoop, a bowl or a container for the transportation, selling, purchasing or feeding of the consumable product.

3. The system of claim 2, wherein the date and time indicia are disposed along a length or about a circumference of the consumable product handling apparatus.

4. The system of claim 3, wherein the markers are slidable relative to the date and time indicia.

5. The system of claim 3, wherein the markers are rotatable relative to the date and time indicia.

6. The system of claim 1, wherein the consumable product handling apparatus comprises a food container.

7. The system of claim 1, wherein the date indicia or time indicia are removably attached for accommodating different languages.

8. A consumable product use tracking system, comprising:
a consumable product handling apparatus;
a roller rotatable relative to the apparatus;
date or time indicia associated with the roller; and
a roller positioning mechanism associated with the roller, the apparatus, or both, for securely holding the roller so as to identify a distinct date or time from the date or time indicia and prevent accidental or unintended movement of the roller to another date or time;
wherein the roller is selectively moved to identify the distinct date or time after a last time the consumable product was used.

9. The system of claim 8, wherein the consumable product handling apparatus comprises a scoop, a bowl or a container for the transportation, selling, purchasing or feeding of the consumable product.

10. The system of claim 9, including the step of utilizing the consumable product handling apparatus to identify the distinct date and time of a current use of the consumable product.

11. The system of claim 10, including the step of selectively moving the roller to identify the distinct date and time of the current use of the consumable product.

12. The system of claim 8, wherein the consumable product handling apparatus comprises a means for attachment to a scoop, bowl or container.

13. The system of claim 12, wherein the means for attachment comprises an adhesive, a magnet, a vacuum cup, or a hook and loop fastener with adhesive backing.

14. A consumable product use tracking system, comprising:
a body;
a battery associated with the body;
an electronic processor electrically connected to the battery, wherein the processor internally tracks the current date or time;
one or more buttons accessible by a user and in communication with the processor; and
an electronic readout associated with the processor;
wherein the button pressed by the user displays on the electronic readout a static and distinct date or time corresponding to a last time the consumable product was used.

15. The system of claim 14, including the step of attaching the body to a consumable product handling apparatus.

16. The system of claim 15, wherein the consumable product handling apparatus comprises a scoop, a bowl or a container for the transportation, selling, purchasing, or feeding of the consumable product.

17. The system of claim 16, including the step of utilizing the consumable product handling apparatus to identify the static and distinct date and time of use of the consumable product.

18. The system of claim 14, wherein the body comprises a means for attachment to a scoop, bowl or container.

19. The system of claim 18, wherein the means for attachment comprises an adhesive, a magnet, a vacuum cup, or a hook and loop fastener with adhesive backing.

20. The system of claim 14, including a timer and an alarm both associated with the processor, wherein the alarm sounds after a predetermined time has elapsed.
